(19) United States
(12) Patent Application Publication
(10) Pub. No.: US 2026/0022792 A1
(43) Pub. Date: Jan. 22, 2026

(54) Circuit Breaker and Installation for Handling Pressurized Fluid Comprising Such a Circuit Breaker

(71) Applicant: STAUBLI FAVERGES, Faverges-Seythenex (FR)

(72) Inventors: Serafim Marques Barroca, Albertville (FR); Romain Mayer, Ugine (FR)

(21) Appl. No.: 19/273,038

(22) Filed: Jul. 17, 2025

(30) Foreign Application Priority Data
Jul. 18, 2024 (FR) 2407896

(51) Int. Cl. F16L 37/32; F16L 37/23

(52) U.S. Cl. CPC F16L 37/32; F16L 37/23

(57) ABSTRACT

In the coupled configuration of the male and the female elements of the circuit breaker, the first and second radial passages are in fluid communication and the proximal and the distal seals are arranged on either side of the radial passages. A first valve comprises a distal rod sliding in a male body. In an intermediate coupling position, the proximal and the distal seals are arranged on either side of the radial passages. The proximal and the distal seals are respectively received in a proximal external peripheral groove and in a distal external peripheral groove of the male body. A first longitudinal distance, measured between the distal external peripheral groove and a median radial plane of the first radial passage, is strictly greater than a second longitudinal distance, measured between the proximal external peripheral groove and the median radial plane.

### FIELD

The invention relates to a “safety” circuit breaker for a pressurized fluid handling installation, such as, for example, a vehicle tank filling installation with pressurized hydrogen.

### BACKGROUND

To prevent the filling time of a vehicle tank with pressurized hydrogen from being too long, it is known to use a significant filling pressure, greater than 300 bar and up to 900 bar. Given this pressure level, the connection between the hydrogen source and the vehicle tank must be airtight.

Furthermore, an accidental displacement of the vehicle tank during filling cannot be excluded, such a displacement might result from poor immobilization of the vehicle or a false move on the part of a user. Such a displacement should not induce alteration or venting of the pipeline connecting the pressurized hydrogen source to the vehicle tank.

To address this issue, EP3457016B1 discloses a circuit breaker with locking of a male element in a female element by means of balls elastically recalled to the locking position. In this equipment, which generally provides satisfaction, a full internal valve of the male element is operated by an actuation rod distinct from this valve. The female element also comprises a valve. During the disconnection of the male and the female elements of the circuit breaker, upon closing the valves, a volume of fluid, called dead volume, is trapped downstream of the valves. When the fluid is under pressure, notably above 300 bar, this dead volume tends to deform seals installed between the bodies of the male and the female elements, in their parts located outside their respective receiving grooves, to alter them, or even to eject them from these grooves. For this reason, EP3457016B1 proposes that distal and proximal seals be chosen with a high torus diameter relative to their internal diameter. This results in a relatively large radial and longitudinal bulk of the circuit breaker, which is not compatible with certain high-pressure filling applications, for which optimal compactness is required. Indeed, given the pressures considered, a relatively large diameter of the male and the female elements of a circuit breaker induces high pressure forces, due to the fluid present within the circuit breaker.

Similar problems arise in other pressurized fluid handling installations, notably a vehicle tank filling installation with pressurized natural gas.

There is therefore a need for a circuit breaker presenting an improved radial and/or axial compactness.

### SUMMARY

To this end, the invention relates to a circuit breaker for connecting two pipeline sections of a pressurized fluid handling installation, this circuit breaker comprising a male element and a female element intended to fit into each other according to an insertion axis, the male element comprising:
a male body centered on the insertion axis and comprising:
a first internal conduit for circulating pressurized fluid;
at least one first radial passage connecting the first internal conduit to an external peripheral surface of the male body; and
an external locking notch,
a first valve, movable in the first internal conduit, according to the insertion axis, between an advanced closed position of the first internal conduit and a retracted open position of the first internal conduit, and comprising a sealing portion, which is in longitudinal abutment against the male body in the closing position of the first valve,
a spring pushing the first valve toward the advanced closed position,
the female element comprising:
a female body comprising a second internal conduit for circulating pressurized fluid and at least one second radial passage connecting the second internal conduit to an internal receiving volume of the male body in the female body;
a second valve movable in the second internal conduit at least one locking member received in a locking housing and configured to move from a first locking position, where the locking member is engaged in the external locking notch, to oppose the axial withdrawal of the male body from the female body in the coupled configuration of the male and the female elements, to a second release position, where the axial withdrawal of the male body from the female body is possible.

In the coupled configuration of the male and the female elements,
the first and second radial passages are in fluid communication;
the, or each locking member is in the first locking position;
the first valve is in the retracted open position;
a proximal seal and a distal seal are arranged, along the insertion axis, on either side of the first and second radial passages and cooperate radially respectively with an internal radial surface of the female body delimiting the internal volume and with the external peripheral surface of the male body to fluidly isolate the first and second radial passages from the outside of the circuit breaker.

In accordance with the invention, the first valve also comprises a distal rod that is slidably mounted, between the advanced closed position and the retracted open position, in a housing of the male body passing through a distal end of the male body,
a first radial seal of the rod cooperates radially with the distal rod and with the distal end of the male body;
the female element comprises a bearing surface configured to come into contact with the first valve and displace it, during an insertion of the male and the female elements, from the advanced closed position to the retracted open position;
in an intermediate coupling position of the male and the female elements,
the first valve is in the advanced closed position and in contact with the bearing surface of the female element;
each locking member is not in the first locking position;
the proximal seal and the distal seal are arranged, along the insertion axis, on either side of the first and second radial passages and fluidly isolate the first and second radial passages from the outside of the circuit breaker;
the proximal seal and the distal seal are respectively received in a proximal external peripheral groove and in a distal external peripheral groove of the external peripheral surface of the male body;
a first longitudinal distance, measured parallel to the insertion axis between the distal external peripheral groove and a median radial plane of the first radial passage, is strictly greater than a second longitudinal distance, measured parallel to the insertion axis between the proximal external peripheral groove and the median radial plane.

By means of the invention, the fact that the first valve also comprises the distal rod, in other words, the fact that the distal rod is monobloc with the rest of the first valve, allows for reliable operation of the valve. Furthermore, the positioning of the proximal and the distal seals in the external grooves of the male body allow to limit their ejection from the external grooves under the effect of the fluid pressure during the disconnection of the male and the female elements of the circuit breaker. The fact that the first longitudinal distance is greater than the second longitudinal distance ensures optimized positioning of the proximal and the distal seals vis a vis the second or each radial passage, during the coupling of the male and the female elements of the circuit breaker. In summary, the circuit breaker of the invention presents increased radial and axial compactness, for a passage section and flow rate comparable to those of prior art equipment. Furthermore, the number of seals used between the male and the female elements of the circuit breaker remains minimal, with a proximal seal and a distal seal. Their friction length, during coupling or disconnection of the male and the female elements of the circuit breaker, is advantageously limited.

According to advantageous but non-mandatory aspects of the invention, such a circuit breaker may incorporate one or more of the following features, taken in any technically admissible combination:

A ratio between the first longitudinal distance and the second longitudinal distance is greater than or equal to 1.5, preferably 1.75.

The female body comprises at least one first vent, which radially traverses the female body and which fluidly connects the internal volume in front of the second radial passage and the outside of the circuit breaker, and at least one second vent which radially traverses the female body and which fluidly connects the internal volume of the female body, behind the second radial passage, and the outside of the circuit breaker, while, in the coupled configuration of the male and the female elements and in the intermediate coupling position, the first and second radial passages are isolated from the first and second vents respectively by the proximal and the distal seals.

During disconnection of the male and the female elements from the coupled configuration, the distal seal is radially facing the second radial passage when the proximal seal comes to radially face the first vent.

The first vent and the second passage each open onto an internal radial surface of the female body at the level of recessed pockets, locally around the insertion axis, from this internal radial surface.

The first vent comprises a cylindrical portion inclined relative to the insertion axis and the rear end of which opens onto an external radial surface of the female body and is arranged behind a front end of the cylindrical portion.

The circuit breaker comprises several locking members, each locking member is a ball movable in a locking housing that radially traverses the female body, the female element, comprising a locking ring that is slidably mounted around the female body and which surrounds the locking members, the locking ring being elastically recalled toward the rear, the locking ring being in contact at the rear, in the coupled configuration of the male and the female elements, with the balls by an internal covering surface, inclined relative to the insertion axis and diverging toward the rear of the female body.

The locking member is a locking spring housed in a locking housing formed by an internal peripheral groove of the female body and the locking spring is configured to elastically deform between its first locking position and its second release position.

Each second radial passage is longitudinally delimited by a first part and by a second part of the female body, distinct from the first part, the second part and the first part being securely joined in longitudinal abutment against each other, and, in the coupled configuration and in the intermediate coupling configuration, the proximal seal cooperates radially with an internal radial surface belonging to the first part and the distal seal cooperates radially with an internal radial surface belonging to the second part.

Each first radial passage and each second radial passage is elongated in section, with a maximum dimension parallel to the insertion axis.

The first valve comprises a proximal rod sliding in a housing of the male body between the advanced closed position and the retracted open position with radial interposition of a second rod seal, the first rod seal is mounted in an internal peripheral groove of the male body, while the second rod seal is housed in an external peripheral groove of the proximal rod and a ratio between, on the one hand, a diameter of the proximal rod and, on the other hand, a diameter of the distal rod is between 0.95 and 1.

The housing of the male body, where the proximal rod is received, is formed in an intermediate part of the male body, mounted in sealed longitudinal contact with a proximal part of the male body, configured to be connected to a pressurized fluid pipeline section, and in sealed longitudinal contact with a distal part of the male body that carries the proximal and the distal seals.

In the coupled configuration of the male and the female elements, a diameter of an internal radial surface of the female body with which the proximal seal cooperates radially is equal to a diameter of an internal radial surface of the female body with which the distal seal cooperates radially and a diameter of an external peripheral surface of the male body with which the proximal seal cooperates radially is equal to a diameter of an external peripheral surface of the male body with which the distal seal cooperates radially.

The bearing surface configured to come in contact with the first valve is formed on the female body.

The second valve comprises a distal rod that is slidably mounted in a sealed manner in a through housing of the female body, the male body forms a bearing surface configured to come in contact with the second valve and to displace it, during the insertion of the male and the female elements, from an advanced closed position toward a retracted open position. A contact zone between the bearing surface of the male body and the second valve and a contact zone between the bearing surface of the female body and the first valve are radially offset from each other.

According to a second aspect, the invention relates to a pressurized fluid handling installation comprising a pressurized fluid source and a first part of a connector intended to be coupled to a second part of a connector fitted to a storage or use volume of the fluid, the first part of the connector being fluidly connected to the source by a pipeline, characterized in that a circuit breaker, according to, such as mentioned above, is fluidly connected to the source by a first section of the pipeline and to the first part of the connector by a second section of the pipeline.

This installation is easier to handle than those of the prior art, due to the compactness of the circuit breaker, and its reliability is improved.

The invention will be better understood, and other advantages thereof will become clearer in light of the following description of four embodiments of a circuit breaker and an installation in accordance with its principle, given by way of example and made with reference to the attached drawings in which:

### BRIEF DESCRIPTION OF THE DRAWINGS

FIG. 1 is a schematic representation of a pressurized fluid handling installation that comprises, among other things, a circuit breaker in accordance with a first embodiment of the invention, the male and the female elements of which are represented in a disconnected configuration, in longitudinal section;

FIG. 2A represents a larger scale view of detail II of FIG. 1;

FIG. 2B represents a partial sectional view according to line B-B on FIG. 2A);

FIG. 3 is an exploded perspective view of the circuit breaker of FIGS. 1, 2A and 2B;

FIG. 4A represents, a partial longitudinal section of the male and the female elements of the circuit breaker of FIGS. 1, 2A, 2B, and 3 in a first intermediate coupling position;

FIG. 4B represents a section according to line B-B on FIG. 4A;

FIG. 4C represents a section according to line C-C on FIG. 4A;

FIG. 4D represents a larger scale view of detail D on FIG. 4C;

FIG. 5A represents the male and the female elements of the circuit breaker, in longitudinal section, in a second intermediate coupling position;

FIG. 5B represents a third intermediate coupling position;

FIG. 6A represents the male and the female elements of the circuit breaker, in longitudinal section and in coupled configuration in the same sectional plane as FIGS. 1, 5A, and 5B;

FIG. 6B represents a perpendicular plane represented by the line B-B on FIG. 6A;

FIG. 7 is a longitudinal section of a circuit breaker in accordance with a second embodiment, in a first intermediate coupling position of its male and the female elements;

FIG. 8A represents a longitudinal section of the circuit breaker of FIG. 7 in a second intermediate coupling position;

FIG. 8B represents a transverse section according to the line B-B on FIG. 8A;

FIG. 9A represents a longitudinal section of the circuit breaker of FIGS. 7, 8A and 8B in coupled configuration;

FIG. 9B represents the transverse section according to the lines B-B on FIG. 9A;

FIG. 9C represents the transverse section accordingly to the lines C-C on FIG. 9A;

FIG. 10A represents in longitudinal section, a circuit breaker in accordance with a third embodiment of the invention, in an intermediate coupling position;

FIG. 10b represents in longitudinal section, a circuit breaker in accordance with a third embodiment of the invention, in a coupled configuration;

FIGS. 11A, 11B and 11C represents a circuit breaker according to a fourth embodiment of the invention in a longitudinal section in an intermediate coupling position;

FIG. 11B represents a circuit breaker according to a fourth embodiment of the invention in a coupled configuration;

FIG. 11C represents a circuit breaker according to a fourth embodiment of the invention in a partially exploded perspective.

### DETAILED DESCRIPTION

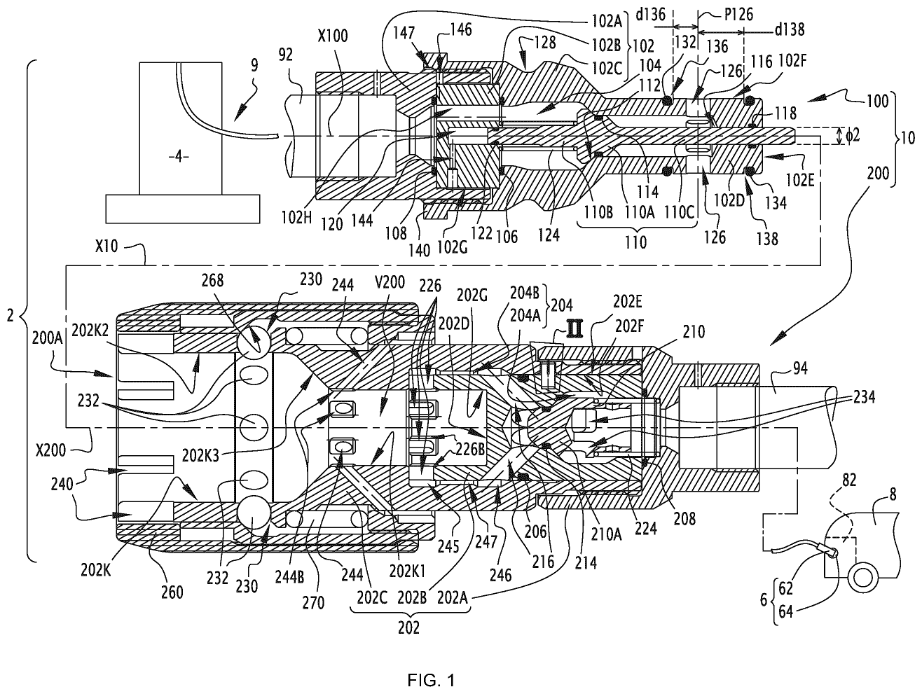

A pressurized fluid handling installation 2 is represented in FIG. 1. It comprises a terminal 4 that forms a source of pressurized fluid, this fluid being, in the example, liquid hydrogen under a pressure between 300 and 900 bar. The installation 2 also comprises a nozzle 62 which constitutes a first part of a connector 6, the complementary second part 64 is mounted on a vehicle 8 which comprises an onboard storage tank 82 for the pressurized fluid. The second part 64 can be coupled to the nozzle 62 when it is necessary to fill the tank 82 with pressurized fluid.

A pipeline 9 connects the terminal 4 to the nozzle 62. A safety circuit breaker 10 according to the invention is interposed along the pipeline 9 and divides it between a first upstream section 92, which extends between the terminal 4 and the circuit breaker 10, and a second downstream section 94, which extends between this circuit breaker 10 and the nozzle 62.

For clarity of the drawing, the elements 4, 6, and 9 of the installation 2 are represented only in FIG. 1.

The circuit breaker 10 comprises a male element 100 and a female element 200.

For each of the male 100 and the female 200 elements, the front of this element is defined as the side of this element oriented toward the other element of the circuit breaker 10 when these male and the female elements are aligned and ready to be fitted into each other. The rear of one of the elements of the circuit breaker is defined as the side opposite to its front side, oriented toward the section 92 or 94 of the pipeline 9 to which it is connected.

For each of the male and the female elements 100 and 200, the adjective “proximal” qualifies a part, a surface, or a volume located closer to the rear of this element than a part, a surface, or a volume qualified as distal. Conversely, the adjective “distal” qualifies a part, a surface, or a volume located closer to the front of one of the male and the female elements 100 and 200 than a part, a surface, or a volume qualified as proximal.

In FIGS. 1, 4A, 4B, 4C, 4D, 5A and 5B, the front or distal side of the element 100 is oriented toward the right, while its rear or proximal side is oriented to the left, the front or distal side of the female element 200 is oriented toward the left of these figures and its rear or proximal side is oriented to the right.

In the following, the adjectives “axial” and “radial” are used to qualify a position or the orientation of a surface depending on a longitudinal axis of the part or subassembly concerned. A surface is axial when it is perpendicular to a longitudinal axis and radial when it is perpendicular to any normal to a longitudinal axis. In particular, a radial surface is a circular-based peripheral surface that is centered on a longitudinal axis and that extends around this axis.

The adjectives “internal” and “external” are used to qualify the orientation of a surface depending on a central longitudinal axis of the part or subassembly concerned. A surface is internal when it is turned toward the central longitudinal axis and external when it is turned away from the central longitudinal axis.

The circuit breaker 10 is intended for the removable connection of sections 92 and 94 to which the male element 100 and the female element 200 are connected.

The male element 100 extends along a longitudinal axis X100 and comprises a tubular male body 102 centered on the longitudinal axis X100 and composed of a proximal part 102A, an intermediate part 102B, and a distal part 102C.

The male body 102 is traversed by a first internal conduit 104 for circulating pressurized fluid, which is connected to the upstream section 92 in the use configuration of the circuit breaker 10. The male body 102 comprises the first internal conduit 104.

The proximal and the distal parts 102A and 102C are screwed together by means of a thread provided on an external radial surface of the proximal part 102A and a tapped thread provided on an internal radial surface of the distal part 102C. The proximal and the distal parts 102A and 102C sandwich between them, according to a direction parallel to the longitudinal axis X100, the intermediate part 102B.

The distal part 102C is directly in contact, by its rear side, against the intermediate part 102B. A frontal seal 106, interposed between a rear axial surface of the distal part 102C and a front axial surface of the intermediate part 102B, ensures the sealing of the internal conduit 104 at the interface between the distal 102C and the intermediate 102B parts.

The proximal part 102A is directly in contact, by its front side, against the intermediate part 102B. A frontal seal 108, interposed between a front axial surface of the proximal part 102A and a rear axial surface of the intermediate part 102B, ensures the sealing of the internal conduit 104 at the interface between the proximal 102A and the intermediate 102B parts.

The frontal seals 106 and 108 are not subjected to a force that would tend to expel them from their respective housings under the effect of the pressure prevailing in the male body 102.

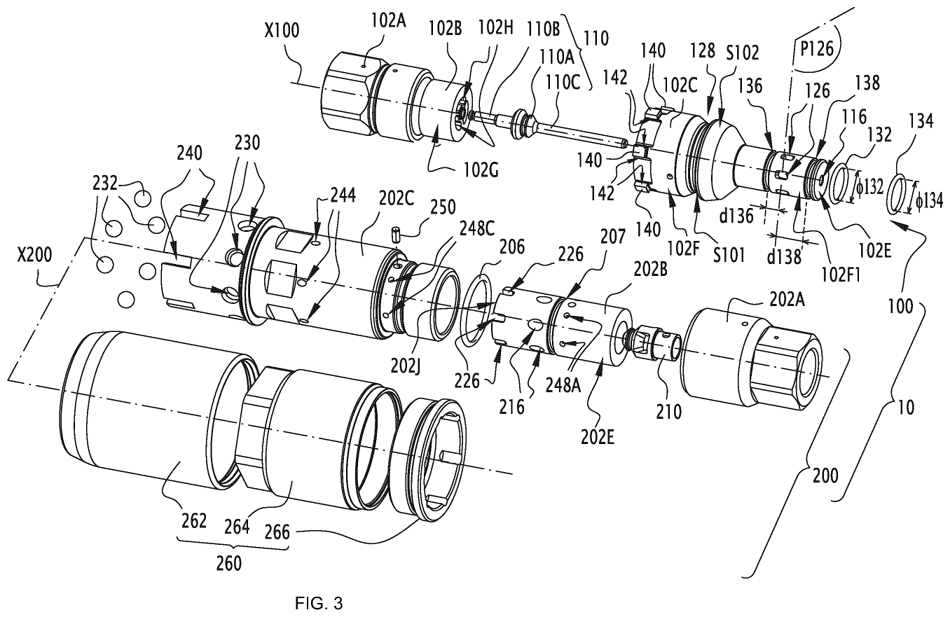

Three passage conduits traverse the intermediate part 102B from end to end according to the longitudinal axis X100 and are part of the internal conduit 104. Only one of these passage conduits is visible in FIG. 1, with reference 102H. The three conduits in question are visible in FIG. 3.

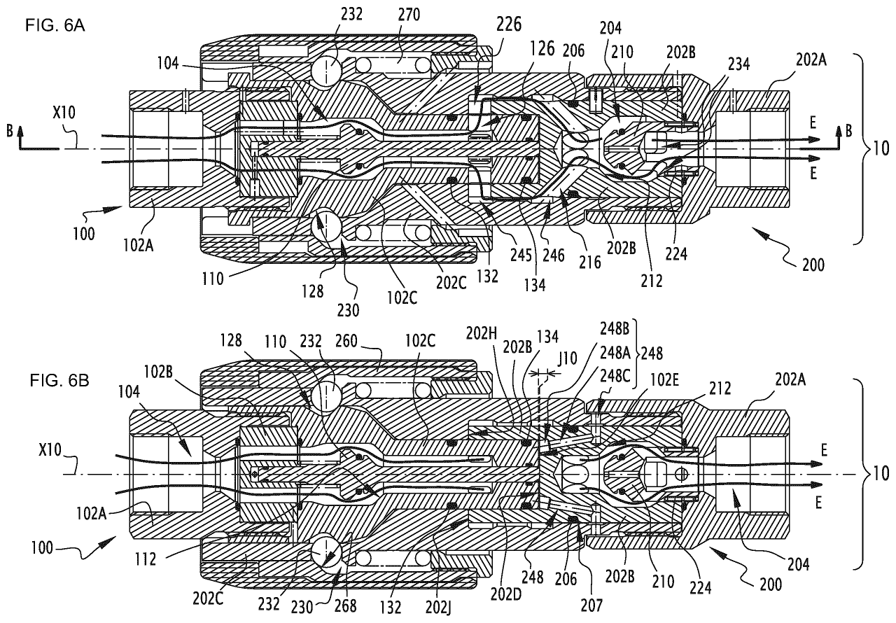

A valve 110 of the male element 100 is movable, in the internal conduit 104, between an advanced closed position of this conduit, which is represented notably in FIG. 1 and where it is in front abutment against a seat 112 formed on the distal part 102C of the male body, and a retracted open position, represented notably in, FIGS. 6A and 6B, where it is offset from its seat 112 and opens the internal conduit 104 of the male element 100.

A seal 114 is mounted on the valve 110 and cooperates radially with the distal part 102C of the male body 102 in the advanced closed position of this valve, to ensure the sealing of the closure of the internal conduit 104. This seal 114 is not in contact with the male body 102 in the retracted open position of the valve 110.

The valve 110 is monobloc and comprises a valve head 110A, which carries the seal 114 and which is in abutment against the seat 112, in other words, in longitudinal abutment in front of, or toward the front, in the advanced closed position of the valve. The valve head 110A constitutes a selective closing portion of the internal conduit 104. The valve 110 also comprises a proximal rod 110B and a distal rod 110C, formed in one piece with the valve head 110A.

The distal end of the male body 102, which is formed by the distal end of the distal part 102C, is denoted 102D. The distal rod 110C passes through the distal end 102D while being received in a through housing 116 that extends through the distal end 102D, along the longitudinal axis X100. A first rod seal 118 is mounted in an internal peripheral groove of the distal end 102D that opens into the through housing 116. This first rod seal 118 cooperates radially with the distal end 102D and with the distal rod 110C and slides along an external radial surface of the distal rod 110C when it displaces axially relative to the male body 102.

The proximal rod 110B is engaged in a housing 120 centered on the longitudinal axis X100 and provided in the intermediate part 102B. A second rod seal 122 is mounted in an external peripheral groove of the proximal rod 110B and cooperates radially with this proximal rod 110B and an internal radial surface delimiting the housing 120. The second rod seal 122 slides along the internal radial surface delimiting the housing 120 when the proximal rod is displaced axially relative to the male body 102.

A spring 124 is interposed between the intermediate part 102B and the head 110A, around the proximal rod 110B, inside the internal conduit 104. The spring 124 exerts, by default, an elastic pushing force on the valve 110 toward its advanced closed position.

The diameter of the external radial surface of the proximal rod 110B, from which the external peripheral groove housing the second rod seal 122 is formed is denoted ϕ1. The diameter of the external radial surface of the distal rod 110C, which defines a sealing diameter between the first rod seal 118 and the peripheral surface of the distal rod 110C, is denoted ϕ2. The diameter of the bottom of the external peripheral groove of the second rod seal 122, that defines a sealing diameter between the second rod seal 122 and the proximal rod 110B, is denoted ϕ1′. The diameters ϕ1 and ϕ2 are substantially equal. In practice, the ratio ϕ1/ϕ2 is between 0.95 and 1, while being preferably strictly less than 1. Thus, with a first rod seal 118 mounted in a bore and a second rod seal 100 mounted on a rod, the sealing diameter ϕ1′ of the rod seal 122 with the valve 110 is strictly less than the sealing diameter ϕ2, which has the effect that the pressure of the fluid contained in the internal conduit 104 does not exert an opening force on this valve in the coupled configuration. Indeed, when the diameter ϕ1′ is strictly less than the diameter ϕ2, the pressure of the fluid contained in the internal conduit tends to bring the valve 110 back toward its advanced closed position. This difference between the diameters ϕ1′ and ϕ2 contributes to the safety of the closure of the valve 110, and therefore of the emergency unlocking since the spring 124 does not have to be oversized to guarantee the closure of the valve 110.

In the disconnected configuration represented in FIG. 1, the distal rod 110C protrudes forward from the male element 100 relative to a front axial surface of the end 102E of the distal end 102D, therefore, from the male body 102.

The distal part 102C of the male body 102 forms several first radial passages 126, in the example, six first radial passages, which are regularly distributed around the longitudinal axis X100 and which present, preferably, an elongated section parallel to this axis, this elongated section being visible in FIG. 3. The male body 102 comprises the first radial passages 126. Advantageously, a length of each first radial passage 126, which constitutes the maximum dimension of this radial passage, and which is measured parallel to the longitudinal axis X100, is strictly greater than a width of this first radial passage which is measured according to an ortho-radial direction to the longitudinal axis X100. Each radial passage 126 is a cylindrical volume the base of which is elongated in section and the cylinder axis of which is radial to the longitudinal axis X100.

The number of radial passages 126 may be different from six. In practice, this number is chosen to be greater than or equal to one, preferably between one and ten, depending on the respective dimensions of the distal part 102C and the radial passages 126.

Each radial passage 126 connects the internal conduit 104 and an external peripheral surface 102F of the distal part 102C, in a front portion 102F1 of this surface 102F which is circular in section and with a straight generatrix.

The distal part 102C also forms an external locking notch 128, in other words, an external peripheral locking groove, which is provided on the external peripheral surface 102F, being axially offset toward the rear relative to the first radial passages 126. The male body 102 comprises the external locking notch 128.

The front portion 102F1 of the external peripheral surface 102F carries two toroidal seals, arranged on either side of the first radial passages 126, along the longitudinal axis X100, namely a proximal seal 132 and a distal seal 134. Each of the proximal and the distal seals 132 and 134 is respectively received in an external peripheral groove of the external peripheral surface 102F, namely respectively a proximal external peripheral groove 136 and a distal external peripheral groove 138.

Advantageously, the proximal external peripheral groove 136 and the distal external peripheral groove 138 are identical.

The median radial plane of the first radial passages 126 is denoted P126.

A distance measured between the median radial plane P126 and the edge of the groove 136 closest to the first radial passages 126 is denoted d136. A distance measured axially between the median radial plane P126 and the edge of the groove 138 closest to the first radial passages 126 is denoted d138. The axial distances d136 and d138 are measured parallel to the longitudinal axis X100.

The distance d138 is strictly greater than the distance d136.

In other words, the proximal seal 132 is closer to the first radial passages 126 than the distal seal 134.

Advantageously, the distance d138 is at least one and a half times greater than the distance d136, preferably 1.75 times greater. In other words, a ratio d138/d136 is greater than or equal to 1.5, preferably 1.75.

### The Relationships are:

$$d 138 / d 136 \geq 1.5 \qquad ( equation 1 )$$

$$preferably d 138 / d 136 \geq 1.75 \qquad ( equation 1 bis )$$

Advantageously, the proximal and the distal seals 132 and 134 are identical.

The internal diameter of the seal 132 is denoted Ø132 and the internal diameter of the seal 134 is denoted Ø134. The torus diameter of the seal 132 is denoted φ132 and the torus diameter of the seal 134 is denoted φ134.

Advantageously, for each seal, its torus diameter is much smaller than its internal diameter, preferably at least 5 times smaller than the internal diameter, preferably even at least 10 times smaller than the internal diameter.

### The Relationships are:

$$∅132 \geq 5 \times φ 132 \qquad ( equation 2 )$$

$$preferably ∅132 \geq 10 \times φ 132 \qquad ( equation 2 bis )$$

$$∅134 \geq 5 \times φ 134 , \qquad ( equation 3 )$$

$$preferably ∅134 \geq 10 \times φ 134 \qquad ( equation 3 bis )$$

The external locking notch 128 is longitudinally delimited by a distal inclined surface S128 located on the front side of this notch and a proximal inclined surface S′128 located on the rear side of the locking notch.

The distal inclined surface S128 extends, in the direction of the distal end 102D of the male body 102, by a radial surface S101 parallel to the longitudinal axis X100 then an external surface S102, inclined relative to the longitudinal axis X100, the external inclined surface S102 being the closest to the distal end 102D from among these two surfaces S102 and S128.

In practice, the surfaces S128, S′128, and S102 are advantageously in the shape of a truncated cone, while the surface S101 is advantageously in the shape of a cylinder with a straight generatrix and a circular base.

The distal inclined surface S128 diverges toward the front, in other words, approaching the distal end 102D along the longitudinal axis X100, while the proximal inclined surfaces S′128 and the external S102 converge toward the front, approaching the distal end 102D along the longitudinal axis X100.

The angle of inclination of the proximal inclined surface S128 relative to the longitudinal axis X100 is denoted α. Advantageously, the angle α is between 40° and 50°, preferably equal to about 45°.

The angle of inclination of the external inclined surface S102 relative to the longitudinal axis X100 is denoted β. Advantageously, the angle β is between 12° and 20°, preferably equal to about 15°.

The male body 102 also comprises external radial teeth 140 which extend from the external peripheral surface 102F, near a rear end of the distal part 102C. Each tooth 140 is delimited, according to an ortho-radial direction, to the longitudinal axis X100, by two faces 142 which are parallel to a longitudinal plane passing through the middle of the tooth 140 in question, equidistant from these faces and containing the longitudinal axis X100. The external radial teeth 140 are regularly distributed around the longitudinal axis X100, at the rear end of the distal part 102C and angularly arranged in a precise and predetermined manner relative to the first radial passages 126.

In the example of the figures, the number of teeth 140 is equal to six. Alternatively, it may be different, while remaining greater than or equal to 1.

The housing 120 of the intermediate part 102B of the male body 102 is connected to the outside of the male element 100 at the rear of the proximal rod 110B, in all positions of the valve 110 vis a vis the male body 100, notably when this valve is in the advanced closed position and in the retracted open position. To do this, a vent 144 is provided in the intermediate part 102B and extends, radially to the longitudinal axis X100, between the housing 120 and an external peripheral surface 102G of the intermediate part 102B. This vent 144 communicates through a radial hole 146 provided through the proximal part 102A then through a radial space 147 provided between the proximal and the distal parts 102A and 102C, which is not sealed. Air coming from the housing 120 can thus escape toward the outside of the male element 100 through the vent 144, the radial hole 146, and the radial space. The vent 144 is isolated from the internal conduit 104 by the frontal seals 106 and 108 and by the second rod seal 122, so that the fluid passing through the circuit breaker in the coupled configuration of the male 100 and the female 200 elements does not risk escaping from the circuit breaker through the vent 144.

The female element 200 extends along a longitudinal axis X200 and comprises a tubular female body 202 centered on the longitudinal axis X200 and composed of a proximal part 202A, an intermediate part 202B, and a distal part 202C.

The female body 202 is traversed by a second internal conduit 204 for circulating pressurized fluid which is connected to the downstream section 94 in the use configuration of the circuit breaker 10. The female body 202 comprises the second internal conduit 204.

During the coupling of the male and the female elements 100 and 200 and in the connected configuration of these elements, the longitudinal axes X100 and X200 are coincident and aligned on an insertion axis X10 of the circuit breaker 10.

The intermediate part 202B and the distal part 202C together delimit an internal volume V200 of the female element 200 configured to receive a part of the male element 100 during coupling and in the coupled configuration of the male and the female elements 100 and 200.

The intermediate part 202B forms a bearing surface 202D which longitudinally delimits, at the rear, the internal volume V200. The bearing surface 202D is an internal surface, axial relative to the longitudinal axis X200.

The proximal and the distal parts 202A and 202C are screwed together, by means of a thread provided on an external radial surface of the distal part 202C and a tapped thread provided on an internal radial surface of the proximal part 202A. The proximal and the distal parts 202A and 202C sandwich between them, according to a direction parallel to the longitudinal axis X200, the intermediate part 202B.

A radial seal 206 is arranged radially between the intermediate part 202B and the distal part 202C. The seal 206 is housed in an external peripheral groove 207 provided on an external radial surface 202E of the intermediate part 202B.

A frontal seal 208 is interposed between the intermediate part 202B and the proximal part 202A, at a contact zone where an axial surface contact occurs between the parts 202A and 202B.

The external radial surface 202E cooperates with reduced play with an internal radial surface 202F of the distal part 202C, over more than one-third of the length of the intermediate part 202B measured parallel to the longitudinal axis X200. This reduced play cooperation of the surfaces 202E and 202F ensures good coaxiality of the intermediate the and the distal parts 202B and 202C of the female body 202.

The internal conduit 204 comprises a rear portion 204A centered on the longitudinal axis X200 and in which a monobloc valve 210 of the female element 200 is housed.

The valve 210 is movable, in the rear portion 204A of the internal conduit 204, between an advanced closed position of this conduit, which is represented notably in FIG. 1 and where a head 210A of this valve is in front abutment against a seat 212 formed on the intermediate part 202B of the female body, and a retracted open position, represented notably in FIGS. 6A and 6B, where it is offset from its seat 212 and opens the internal conduit 204 of the female element 200. The valve head 210A constitutes a selective sealing portion of the internal conduit 204.

A seal 214 is mounted on the valve 210 and cooperates radially with the intermediate part 202B of the female body in the advanced closed position of this valve. This seal is not in contact with the female body 202 in the retracted open position of the valve 210.

A spring 224 interposed between the proximal part 202A and the valve 210 pushes by default the valve 210 toward its advanced closed position, in abutment against the seat 212.

The internal conduit 204 also comprises an intermediate part 204B arranged radially inside the distal part 202C, around the intermediate part 202B.

The inclined passages 216 traverse the intermediate part 202B and extend from the intermediate part 204B of the internal conduit 204, toward the rear part 204A of this internal conduit, in front of the seat 212. In practice, the inclined passages 216 are part of the internal conduit 204 and connect its intermediate 204B and rear 204A parts.

The inclined passages 216 are, for example, six in number and all have the same inclination relative to the longitudinal axis X200. The inclined passages 216 diverge in the direction of the front of the female element 200. The angle of inclination of an inclined passage 216 relative to the longitudinal axis X200 is denoted Y. The value of the angle Y is advantageously between 40° and 50°, preferably of the order of 45°.

In one alternative, not represented, of the invention, the number of inclined passages 216 is different from six, being greater than or equal to one.

The second radial passages 226 connect the intermediate part 204B of the internal conduit 204 and a first internal radial surface 202G of the intermediate part 202B which participates in the radial delimitation of the volume V200. Thus, the second radial passages 226 connect the intermediate part 204B of the internal conduit 204 to the volume V200, by radially traversing the intermediate part 202B of the female body 202.

The second radial passages 226 are regularly distributed around the longitudinal axis X200. In the example of the figures, they are six in number.

Alternatively, the number of radial passages 226 may be different, provided it is greater than or equal to 1, the second radial passages being preferably regularly distributed around the axis X200, regardless of their number if it is greater than or equal to 2.

Advantageously, the number of second radial passages 226 is equal to the number of first radial passages 126.

The second radial passages 226 are delimited by notches provided on a front edge 202J of the intermediate part 202B and are delimited, at the front, by a rear axial surface 202H of the distal part 202C. At the rear and according to a circumferential direction relative to the longitudinal axis X200, the second radial passages 226 are delimited by the material of the intermediate part 202B. The front edge 202J of the intermediate part 202B is maintained in surface contact with the rear axial surface 202H of the distal part 202C due to the intermediate part 202B being sandwiched between the proximal and the distal parts 202A and 202C of the female body 202. This realization of the second radial passages 226 provides good axial compactness to the circuit breaker of the invention.

The second radial passages 226 each have a section, taken in an ortho-radial plane to the longitudinal axis X200, substantially identical to a section of the first radial passages 126 taken in an ortho-radial plane to the longitudinal axis X100. Thus, the second radial passages 226 are elongated in section, in the sense that their length, measured parallel to the longitudinal axis X200, is strictly greater than their width, measured in an ortho-radial direction to the axis X200. The elongated shape of the first and second radial passages 126 and 226 allows to obtain maximum fluid flow inside the circuit breaker 10, in the coupled configuration of the male and the female elements 100 and 200, while its radial compactness is improved and the pressure losses of the circuit breaker 10 on the flow of pressurized fluid are minimized in the coupled configuration of the male 100 and the female 200 elements.

The locking housings 230 with a circular base cylindrical section radially traverse the distal part 202C, in front of the second radial passages 226. These locking housings 230 open at an internal surface 202K of the distal part 202C which also radially delimits the internal receiving volume V200. More precisely, the locking housings 230 open at a second internal radial surface 202K2 of the distal part 202C which is a front part of the internal surface 202K. In practice, the volume V200 is radially delimited to the axis X200, by the first internal radial surface 202G at the axial level of the intermediate part 202B and by the internal surface 202K at the axial level of the distal part 202C. Although formed on the different parts 202B and 202C of the body 202, the surfaces 202G and 202K together form the internal peripheral surface of this female body.

The first radial surface 202G is of constant diameter over its axial length, while a diameter of the internal surface 202K increases as it approaches the opening 200A of the female element 200, through which the male body 102 enters the female body 202 during the insertion of the male and the female elements 100 and 200. The internal surface 202K thus comprises a third internal radial surface 202K1 adjacent, at the front, to the first internal radial surface 202G along the longitudinal axis X200 and of constant diameter equal to that of the first internal radial surface 202G. The internal surface 202K also comprises the second internal radial surface 202K2, which radially delimits the opening 200A and of constant diameter and strictly greater than that of the first internal radial surface 202G. A truncated cone portion 202K3 of the internal surface 202K connects its portions 202K1 and 202K2 and diverges toward the opening 200A. In summary, the internal surface 202K is formed by the union of the surfaces 202K1, 202K2, and 202K3.

Each locking housing 230 receives a locking ball 232 and presents a reduced diameter on its internal radial side, strictly less than the diameter of the balls 232, which allows each ball 232 to be retained inside a housing 230, without it falling completely into the internal receiving volume V200.

Each ball 232 constitutes a locking member and is movable, inside its locking housing 230 between:
a first internal radial locking position, in which the ball protrudes radially into the receiving volume V200 of the male body 102 and, if it is engaged in the external locking notch 128 of the male body 102, opposes the axial withdrawal, out of the female element 200, of the male body 102 fitted into the volume V200 and
a second external radial release position, in which the axial withdrawal of the male body 102 out of the female element 200 is possible.

The geometry of the locking housings 230 and the locking balls 232 is such that the balls are movable, each in its housing 230, only in a radial direction to the longitudinal axis X200.

Each second radial passage 226 is formed by a main cylindrical part 226A the base of which is of oblong section and the cylinder axis A226 of which is radial to the longitudinal axis X200, and a pocket 226B provided in a recess from the internal radial surface 202G. The pockets 226B are regularly distributed around the longitudinal axis X200. A portion of the first internal radial surface 202G extends, circumferentially to the longitudinal axis X200, between two pockets 226B. In other words, the pockets 226B are provided in a recess, locally around the longitudinal axis X200, from this first internal radial surface 202G.

The external geometry of the head 210A is identical to the geometry of the head 110A of the valve 110 of the male element 100. In particular, the truncated cone surfaces of the heads 110A and 210A in contact with their respective seat 112, 212 in the closed position have the same inclination, their grooves in which the seals 114 and 214 are housed, are of the same radial and axial geometry and the seals 114 and 214 are advantageously identical.

The valve 210 is traversed by passages 234 that allow a fluid passing through the circuit breaker 10 to transit between the rear portion 204A of the internal conduit 204 and the downstream section 94 of the pipeline 9. The valve 210 functions as a check valve. It is configured to displace from its advanced closed position toward its retracted open position when the pressurized fluid present in the intermediate part 204B of the internal conduit 204 exerts an axial force directed toward the rear of the female body, to the point of lifting the valve 210 from its seat 212 and releasing a passage for the pressurized fluid which then flows through the circuit breaker, in the direction of the flow arrows E represented in FIGS. 6A and 6B.

Longitudinal notches 240 are formed at the front end of the distal part 202C, with a geometry, complementary to that of the radial teeth 140 of the male body 102.

The first vents 244 are formed in the distal part 202C of the female body 202 and fluidly connect the internal volume V200, in front of the second radial passages 226, and the outside of the female element 200. The first vents 244 radially traverse the female body 202. These first vents 244 open onto the internal surface 202K, at the level of its third internal radial surface 202K1. Each vent 244 comprises a cylindrical bore 244A aligned on an axis A244 and a pocket 244B provided in a recess from the internal surface 202K. The pockets 244B are regularly distributed around the longitudinal axis X200. A portion of the third internal radial surface 202K1 extends, circumferentially, to the longitudinal axis X200, between the two pockets 244B. In other words, the pockets 244B are provided in a recess, locally around the longitudinal axis X200, from this third internal radial surface 202K1.

Each axis A244 is inclined relative to the longitudinal axis X200 and diverging toward the rear of the female body 202. The angle of inclination of an axis A244 relative to the longitudinal axis X200 is denoted δ. Advantageously, the angle θ is between 4° and 50°, preferably of the order of 45°.

Advantageously, a rear end of each cylindrical portion 244A opens onto an external radial surface of the female body 202 and is arranged behind a front end of this cylindrical portion 244A.

Advantageously, the first vents 244 are isolated from the internal conduit 104 in the coupled configuration by the proximal seal 132.

The chosen inclination for the axes A244 prevents moisture, external to the female element 202, notably liquid droplets, from entering the female body 202, when it is arranged in a vertical position, with its distal part 202C oriented upward, which is a conventional position in a circuit breaker.

The internal radial surface 202F of the distal part 202C is provided with a first front internal radial groove 245 and a second rear internal radial groove 246. The grooves 245 and 246 are connected by a peripheral volume 247. In the assembled configuration of the female body 202, the first groove 245 is radially arranged facing the second radial passages 226, while the second rear groove 246 is radially arranged facing the most forward portions of the inclined passages 216. Thus, the first groove 245 constitutes a collector for fluid passing through the second radial passages 226, according to a radial and centrifugal direction relative to the longitudinal axis X200, while the second rear groove 246 constitutes a fluid distributor toward the inclined passages 216 and that the peripheral volume 247 connects the aforementioned collector and distributor.

The second vents 248 are formed in the female body 202 and radially traverse the female body 202. The second vents 248 each comprise a bent bore 248A, a pocket 248B, and a passage 248C. The bent bore 248A and the pocket 248B are provided in the intermediate part 202B, while the passage 248C is provided in the intermediate part 202B and in the distal part 202C. The pockets 248B are provided in a recess in the bearing surface 202D. The second vents 248 open onto this bearing surface. The second vents 248 fluidly connect the internal volume V200, behind the second radial passages 226, with the outside of the female element 200. The second vents 248 open, onto the outside of the female body 202, in an internal volume, delimited between an external radial surface of the proximal part 202C and an internal radial surface of the proximal part 202A, which fluidly communicates with the outside of the female body 202, the second vents 248 being isolated from the internal conduit 104 in the coupled configuration, by the radial seal 206, by the frontal seal 208, and by the distal seal 134.

An indexing pin 250 extends radially to the longitudinal axis X200 and is interposed between the intermediate part 202B and the distal part 202C of the female body 202. This indexing pin 250 forms an obstacle to the relative rotation of the intermediate 202B and the distal 202C parts, which allows for angular indexing of the intermediate part 202B and the distal part 202C around the longitudinal axis X200 relative to each other, which allows to constitute the second vents 248, by radially aligning their parts 248A and 248C. This angular indexing of the parts 202B and 202C also allows for angular orientation of the second radial passages 226 of the female body vis a vis the first radial passages 126, thanks to the cooperation of the teeth 140 and the longitudinal notches 240.

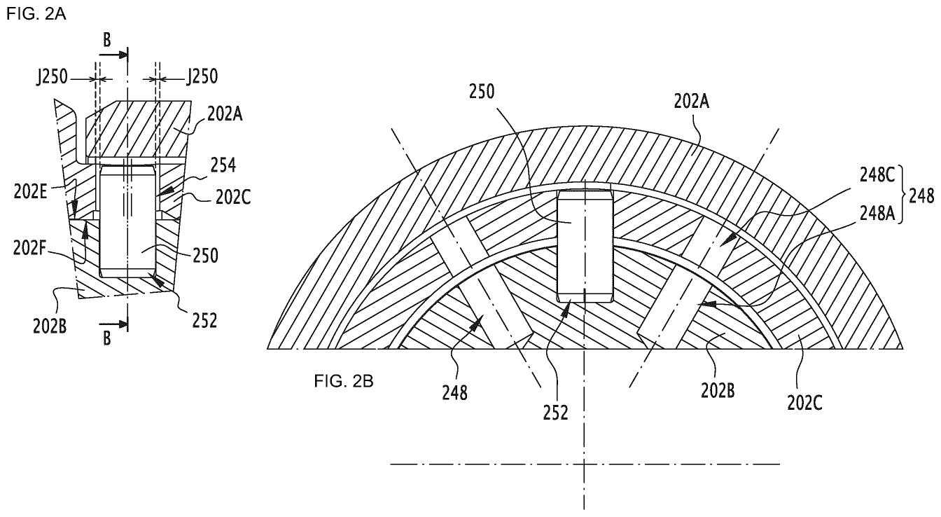

Advantageously, the pin 250 is tightly mounted in a blind radial housing 252 of the intermediate part 202B and with a longitudinal play J250 in an orifice 254, which radially traverses the distal part 202C. This longitudinal play J250 is represented distributed on either side of the pin 250 on FIG. 2A. It allows for the longitudinal abutment positioning of the intermediate part 202D and the distal part 202C to be unhindered, with the front axial surface 202J of the intermediate part 202B in abutment against the rear axial surface 202H of the distal part 202C. The pin 250 is radially covered by the proximal part of the body 202A.

The female element 200 also comprises a locking ring 260 which is in sections and slidably mounted around the distal part 202C of the female body. The locking ring 260 comprises an external sleeve 262, a central part 264, and a sleeve 266. The central part 264 and the sleeve 266, advantageously metallic, are screwed in longitudinal abutment against each other, and the external sleeve 262, advantageously made of elastically deformable polymer material, is placed around the screwed central part 264 and the sleeve 266.

The locking ring 260, more particularly its central part 264, forms an internal covering surface 268 which is inclined relative to the longitudinal axis X200, and which diverges toward the rear of the female body 202. The angle of inclination of the covering surface 268 relative to the longitudinal axis X200 is denoted θ. Advantageously, the angle θ is between 4° and 50°, preferably equal to about 45°. Preferably, the value of the angle of inclination θ is the same as that of the angle of inclination α of the distal surface S128 of the external locking notch 128 of the male body 102. Thus, in the coupled configuration of the male and the female elements 100 and 200 of the circuit breaker 10, the internal covering surface 268 is substantially parallel to the distal surface S128.

A spring 270 is interposed longitudinally between a front face 260A of the locking ring 260 and a rear face 202L of the distal part 202C. The spring 270 elastically pushes by default the locking ring 260 toward the rear of the female body 202, so as to maintain contact between the internal covering surface 268 and the balls 232, which elastically pushes them toward their first locking position.

Thanks to the locking ring 260 and the spring 270, an elastic retention of the male body 102 in contact, in the insertion direction, with the female body 202 in the coupled position of the male and the female elements 100 and 200 is obtained, with maximum flow inside the circuit breaker 10. The elastic recall function of the locking ring can be adjusted by the appropriate sizing of the spring 270.

In all its positions relative to the female body 202, the locking ring 260 is radially clear of the external ends of the first vents 244, more particularly of the external ends of the inclined bores 244A which are provided on the external radial surface of the body 202. The ring 260 does not obstruct these vents 244. In particular, the internal radial notches 266A are advantageously provided in a recess on an internal radial surface of the sleeve 266 to free the exit passage of the first vents 244.

When the male and the female elements 100 and 200 need to be coupled, they are aligned on the insertion axis X10, the longitudinal axes X100 and X200 then being coincident with this insertion axis. In the continuation of the coupling of the male and the female elements 100 and 200 and in the coupled configuration of these elements, the axes X10, X100, and X200 remain coincident.

The coupling takes place by bringing the male and the female elements 100 and 200 closer along the insertion axis X10. This approach can be done by hand or, optionally, and not represented, by means of specific tooling.

Prior to insertion, the radial teeth 140 are aligned longitudinally with the longitudinal notches 240 by angularly orienting the male body 102 relative to the female body 202 around the axis X10, then the male and the female elements 100 and 200 are brought closer by engaging the radial teeth 140 in the longitudinal notches 240, which allows for angular indexing of the male and the female bodies 102 and 202.

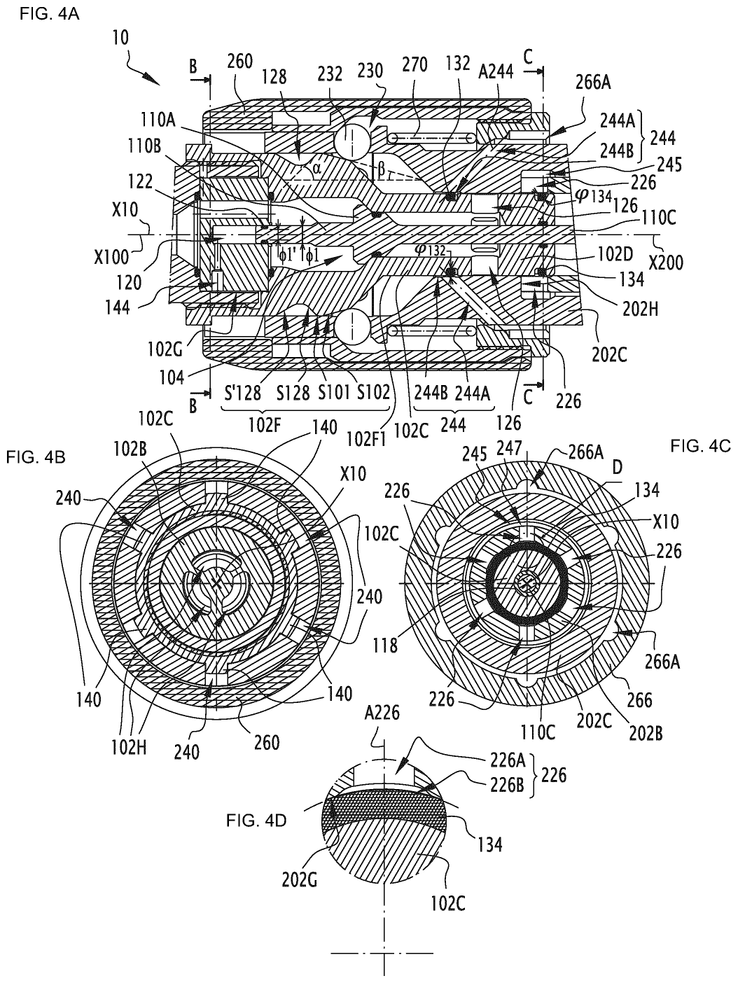

By continuing the insertion movement of the male and the female elements, the balls 232 are pushed by the external inclined surface S102 toward their external radial release position, the locking ring 260 displacing, relative to the balls 232 in the direction of the front of the female body 202 against the action of the spring 270, the internal covering surface 268 of the locking ring 260 being maintained in contact with the balls 232 by the spring 270, as represented in FIGS. 4A, 4B, 4C ad 4D.

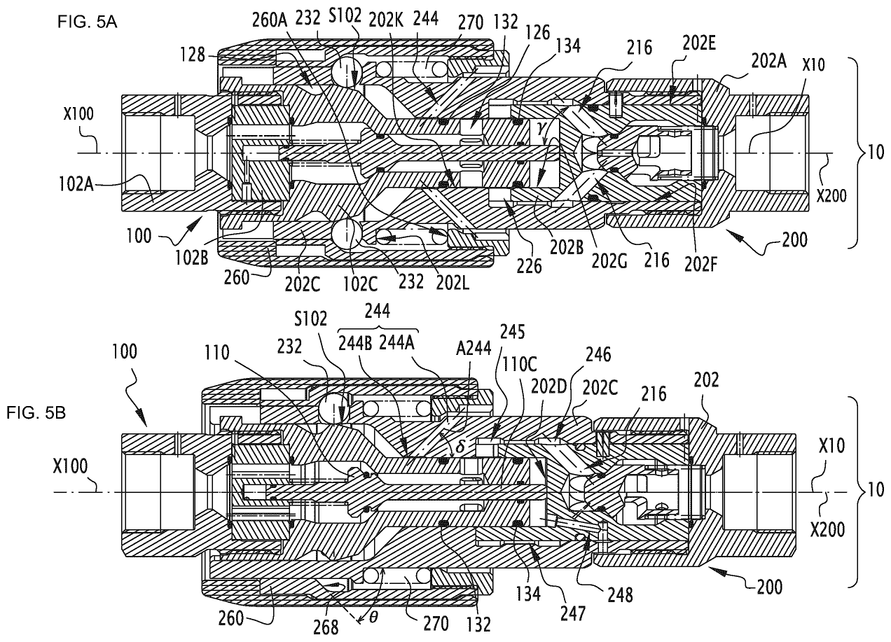

In the second coupling position represented on FIG. 5A, the proximal seal 132 comes into radial cooperation over its entire periphery with the third internal radial surface 202K1 of the distal part 202C, between the opening of the first vents 244 formed by the pockets 244B and the opening of the second radial passages 226 formed by the pockets 226B, while the distal seal 134 comes into radial cooperation over its entire periphery with the first internal radial surface 202G of the intermediate part 202B, between the radial passages 226 and the second vents 248. The balls 232 are still in abutment on the external inclined surface S102. The proximal seal 132 and the distal seal 134 then fluidly isolate the first and second radial passages 126, 226 from the outside of the circuit breaker.

In this second coupling position, the distal rod 110C of the valve 110 comes into abutment against the bearing surface 202D.

Continuing the axial insertion movement has the effect that the bearing surface 202D pushes the distal rod 110C back into the through housing 116 of the distal end 102D of the male body 102, in the direction of the rear of the male body. The distal rod 110C remains in sealed contact with the distal end 102D of the male body 102 over its entire displacement stroke, due to the sealing provided by the first rod seal 118.

This additional axial movement has the effect of displacing the valve 110 of the male element toward its retracted open position of the first internal conduit 104 and reaching the third insertion position represented on FIG. 5B where the balls 232 are in the external radial release position and release the passage of the male body 102 in the female body 202, without yet tilting into the locking housings 230.

During this axial insertion movement, the air trapped in the internal receiving volume V200, between the distal end 102D of the distal part 102C of the male body 102 and the bearing surface 202D of the female body 202, is evacuated toward the outside of the circuit breaker through the second vents 248. The air trapped in the housing 120 of the male body, behind the proximal rod 110B, is evacuated through the vent 144.

Continuing the insertion movement allows the coupled configuration of FIG. 6A to be reached, where the balls 232 are pushed back by the covering surface 268 of the locking ring 260 into their internal radial locking position, where they are engaged in the external locking notch 128 and maintained in it under the action of the locking ring 260 and the spring 270. The balls 232 then form an obstacle to the withdrawal of the male body 102 out of the female body 202.

In this coupled configuration, the first radial passages 126 of the male body 102 are aligned, each, according to a direction, radial to the insertion axis X10, with one of the second radial passages 226 of the female body 202. Also, in this position, the proximal seal 132 and the distal seal 134 fluidly isolate the first and second radial passages 126, 226 from the outside of the circuit breaker.

When the fluid passage is established between the male element 100 and the complementary female element 200 and as explained above, the valve 210 of the female element is displaced by the pressure of the fluid present in the first conduit 104, against the elastic force exerted by the spring 224. Indeed, in the coupled configuration of the male and the female elements 100 and 200, the pressurized fluid present in the conduit 104 flows through the first and second radial passages 106 and 126 which are aligned then in the collector formed by the first front groove 245, in the peripheral volume 247, in the distributor formed by the second rear groove 246 and in the inclined passages 216, which causes it to exert an axial pushing force on the valve 210 toward the rear of the female body 202, with an intensity greater than that of the elastic force exerted by the spring 224.

In particular, in the coupled configuration of the male and the female elements, the internal covering surface 268 of the locking ring 260 is in contact at the front with the balls 232 and maintains these balls in longitudinal contact with the distal surface S128 of the external locking notch 128, which tends to elastically push the male body 102 toward the bearing surface 202D. The fact that the angles α and θ have the same value contributes to the stability of the circuit breaker 10 in this configuration.

In the disconnected configuration of the elements 100 and 200 and in the coupled configuration of these elements, the front end of the distal rod 110C extends forward of the front surface of the end 102E. In particular, a non-zero axial play J10 exists between the axial surfaces 102E and 202D in the coupled configuration.

It is noted that the diameter of the third internal radial surface 202K1 of the peripheral surface 202K, with which the proximal seal 132 cooperates radially over its entire periphery, in the coupled configuration of the elements 100 and 200, is equal to the diameter of the first internal radial surface 202G, with which the distal seal 134 cooperates radially over its entire periphery, in the coupled configuration of the elements 100 and 200. Furthermore, the diameter of the external peripheral surface of the male body 102 with which the proximal seal 132 cooperates radially, in the bottom of the proximal external peripheral groove 136, in the coupled configuration of the elements 100 and 200, is equal to the diameter of the external peripheral surface 102F of the male body 102 with which the distal seal 134 cooperates radially, in the bottom of the distal external peripheral groove 134, in the coupled configuration of the elements 100 and 200. Thus, in the coupled configuration of the male and the female elements, the connection between the male body 102 and the female body 202 is balanced in that the proximal seal 132 and the distal seal 134 cooperate radially respectively with the male body 102 and the female body 202 with the same sealing diameters. Given this geometry of the male and the female elements 100 and 200, the pressure inside the male and the female bodies 102 and 202 does not exert a force that would tend to separate these bodies along the insertion axis X10. Under these conditions, the locking force exerted by the locking ring 260 and the balls 232 must be sized to withstand only a standardized separation force according to the ISO19880-3 or CSA/ANSI HGV 4.4-2017 standard in force to date, this force typically being of the order of 300 to 660 N (Newton). As a result, the safety of the locking in the coupled configuration of the male and the female elements 100 and 200 is improved in that, in the coupled configuration, the pressure in the circuit breaker is balanced.

From the coupled configuration of the elements 100 and 200, if the vehicle 8 moves away from the filling terminal 4, to the point of exerting a force on the pipeline 9 greater than the standardized separation force, a movement of the inclined distal surface S128 of the external locking notch 128 relative to the locking balls 232, in the direction of the rear of the male element 100 causes a displacement of these balls according to a centrifugal direction relative to the insertion axis X10, toward their external radial release position, this against the action of the spring 270. This induces the disconnection of the male and the female elements of the circuit breaker 10.

In the event of disconnection, during the displacement of the male body 102 out of the internal receiving volume V200, the valves 110 and 210 close by being respectively pushed by the springs 124, 224 associated with them. The valve 110 comes into sealed contact with the male body 102, while the distal seal 134 is still interposed between the radial passages 126, 226 and the second vents 248 and the proximal seal 132 is still interposed between the radial passages 126, 226 and the first vents 244, the distal seal 134 and the proximal seal 132 fluidly isolating the radial passages 126, 226 from the outside of the circuit breaker. The closure of the passage of the pressurized fluid in the internal conduit of the circuit breaker 10 formed by the union of the internal conduits 104 and 204 leads to the closure of the valve 210 of the female element which, when it is no longer subjected to fluid pressure, is returned toward its closed position by the spring 224.

The distances d136 and d138 are such that, during the disconnection of the male and the female elements, the distal seal 132 is radially facing the second radial passages 226 when the proximal seal 134 comes to face radially the first vents 244. This induces a quasi-concomitance of the loss of sealing of the distal 134 and proximal 132 seals, which allows for the distribution of the purge of the fluid trapped in the female body 202 and the male body 102 between the two valve heads 210A and 110A, at the level of the two distal 134 and the proximal 132 seals.

Furthermore, the presence of the pockets 226B and 244B allows to maintain the position of the proximal seal 132 and the distal seal 134 during the purge upon disconnection by partial cooperation of the third internal radial surface 202K1 with the proximal seal 132 and partial cooperation of the first internal radial surface 202G with the distal seal 134.

The pressurized fluid trapped in the part of the internal conduit 104 of the male body 102, which is arranged in front of the valve 110, and in the part of the internal conduit 204 of the female body 202, which is arranged in front of the female valve 210, can be quickly purged respectively toward the outside of the circuit breaker via the first and second vents 244 and 248 since the sealing between the distal seal 134 and the female body 202 is interrupted at the level of the second radial passages 226 at the same time as the sealing between the proximal seal 132 and the female body 202 is interrupted at the level of the first vents 244. In other words, the loss of sealing with the female body occurs simultaneously for the first proximal seal 132 and for the distal seal 134.

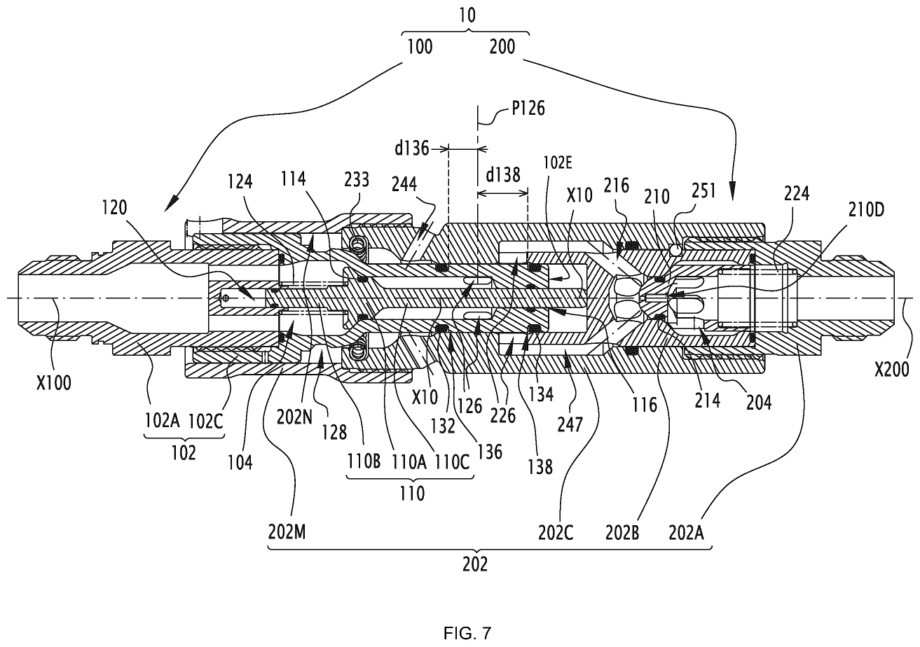

In the second, third, and fourth embodiments represented in FIGS. 7, 8A, 8B, 9A, 9B, 9C, 10A, 10B, 11A, 11B and 11C, the elements similar to those of the first embodiment carry the same references. In the following, if a reference is mentioned in the description without being shown on a figure or shown on a figure without being mentioned in the description, it corresponds to the same element as the one carrying the same reference in the first embodiment. In the following, are described what principally distinguishes the first, second, and third embodiments from the first embodiment.

In the second embodiment represented in FIGS. 7, 8A, 8B, 9A, 9B and 9C, the male body 102 is composed of two parts, namely a proximal part 102A and a distal part 102C which are screwed to each other, without interposition of an intermediate part. A portion of the proximal part 102A constitutes a housing 120, comparable to that of the first embodiment and in which a proximal rod 110B of a valve 110 of this male element is engaged.

A valve 210 is mounted in the body 202 of the female element 200, which is constituted of a proximal part 202A, an intermediate part 202B, and a distal part 202C, as in the first embodiment.

As in the first embodiment, a proximal seal 132 and a distal seal 134 are mounted on either side of the first radial passages 126, respectively in the grooves 136 and 138 located at axial distances d136 and d138 which are different from each other, relative to a median plane P126 of the first radial passages. The distance d138 is strictly greater than the distance d136 and the ratio d138/d136 can take the values indicated above for the first embodiment.

The second radial passages 226 open radially to the outside into a peripheral volume 247 that extends to the inclined passages 216 comparable to those of the first embodiment. In other words, in this second embodiment, no collector or distributor is used as in the first embodiment.

The female body 202 comprises, in addition to the proximal 202A, the intermediate 202B, and the distal 202C parts, a sleeve 202M which is screwed onto the outside of the distal part 202C, and which forms a cylindrical surface 202N, with a circular section around the longitudinal axis X200, for guiding the male body 102 during insertion into the female body 202.

Unlike the first embodiment, the circuit breaker 10 of the second embodiment does not comprise locking balls but a single locking member formed by a spring 233 with inclined coils, which is housed with reduced longitudinal play in an internal peripheral groove 235 of the distal part 202C of the female body 202. This spring can be of the “bal spring” type marketed by Bal Seal Engineering, or any other equivalent type. Preferably, the spring 233 is shaped in a ring. In other words, the spring 233 is contained in a toroidal volume. The spring 233 is welded on itself before being placed in the internal peripheral groove 235; the ring is then closed. Alternatively, the spring 233 is shaped in a ring in the internal peripheral groove 235 from a spring in length. In this latter case, the ring is open. Preferably, the spring 233 extends all around the longitudinal axis X200 when it is in place in the internal peripheral groove 235. It is intended to elastically deform to engage in an external locking notch 128 provided on the external peripheral surface 102F of the male body 102, during the insertion of the male 100 and the female 200 elements. In particular, in contact with the external peripheral surface 102F the diameters of which vary, compression forces perpendicular to the longitudinal axis X200 are applied to the coils of the spring 233. Thus, the spring 233 is configured to move from the first locking position, where the spring 233 is engaged in the external locking notch 128, to oppose the axial withdrawal of the male body 102 out of the female body 202 in the coupled configuration, to the second release position, where the axial withdrawal of the male body out of the female body is possible. Indeed, in the second release position, the spring 233 is compressed in the internal peripheral groove 235 of the distal part 202C and releases the passage for the male body 102 in the internal volume V200 of the female body 202. In the first locking position, the spring 233 forms an obstacle to the passage of the male body 102 in the female body 202 in the direction of the axial withdrawal of the male body 102 out of the female body 202.

No locking ring comparable to the locking ring 260 of the first embodiment is used in the second embodiment.

In so far as the locking spring 233 is hidden inside the female element 200, it cannot be touched, which is favorable in terms of operational safety and reliability of the circuit breaker 10. This also improves the radial compactness of the circuit breaker.

An inclined surface S102, here with a spherical segment geometry, serves to bring the spring 233 into engagement in the locking notch, as in the first embodiment.

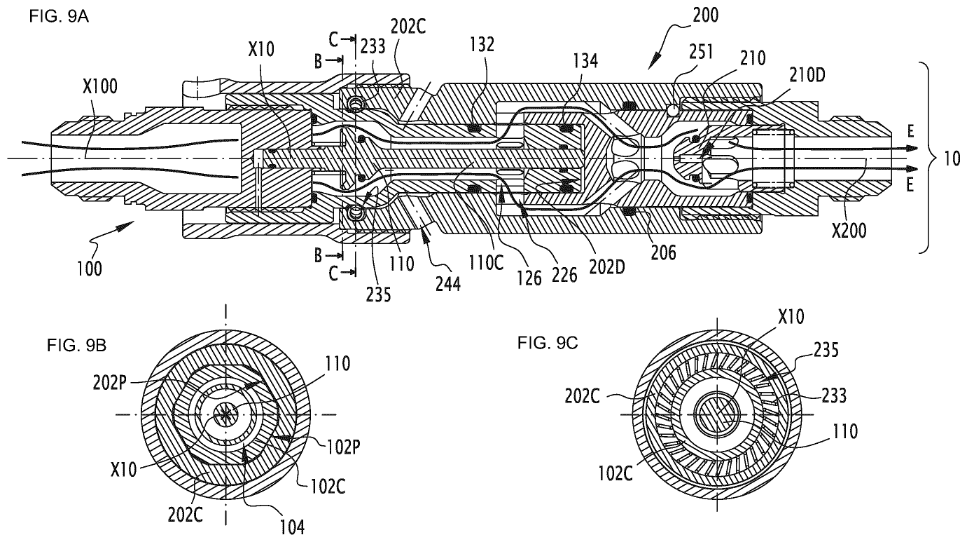

The angular indexing between the male and the female bodies 102 and 202 is obtained by hexagonal shapes visible on FIG. 9B which come into engagement after the passage of the valve 110 of the male element 100 from its advanced closed position to its retracted open position, due to the abutment of the distal rod 110C on a bearing surface 202D formed by the female body 202, as in the first embodiment.

More precisely, an external hexagonal surface 102P of the distal part 102C of the male body and an internal hexagonal surface 202P of the distal part 202C of the female body together constitute indexing means of the male and the female bodies 102 and 202 around the insertion axis X10.

Furthermore, instead of a pin as in the first embodiment, an indexing ball 251 is provided between the intermediate and the distal parts 202B and 202C of the female body. This indexing ball 251 is inserted with reduced radial axial play in a housing provided in one of these parts and with a slight axial play in another housing provided in the other part.

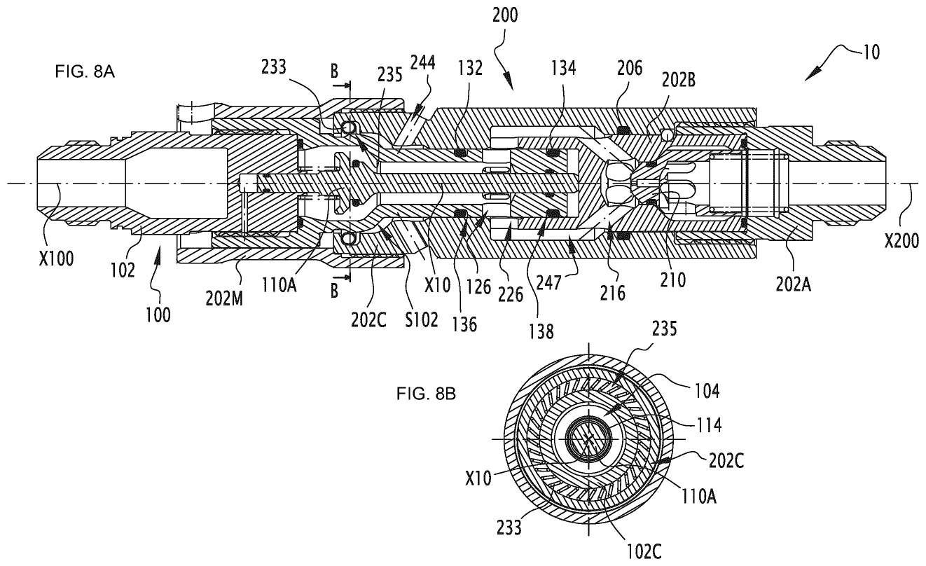

Furthermore, a slow leak passage 210D is provided through the head 210A of the valve 210, which allows fluid flow, at a low and controlled rate, through the valve 210, including when it is in abutment on its seat 212 as in the positions of FIGS. 7, 8A and 8B.

In the coupled configuration of the male and the female elements represented in FIGS. 9A, 9B and 9C, the first radial passages 126 and the second radial passages 226 are axially aligned, along the insertion axis X10 and radially, around this axis.

FIGS. 7, 8A and 8B respectively represent a first position and a second position during the insertion of the male and the female elements 100 and 200, while FIGS. 9A, 9B and 9C represent a coupled configuration of these elements. For the rest, the operation of the circuit breaker 10 of this second embodiment is comparable to that of the first embodiment.

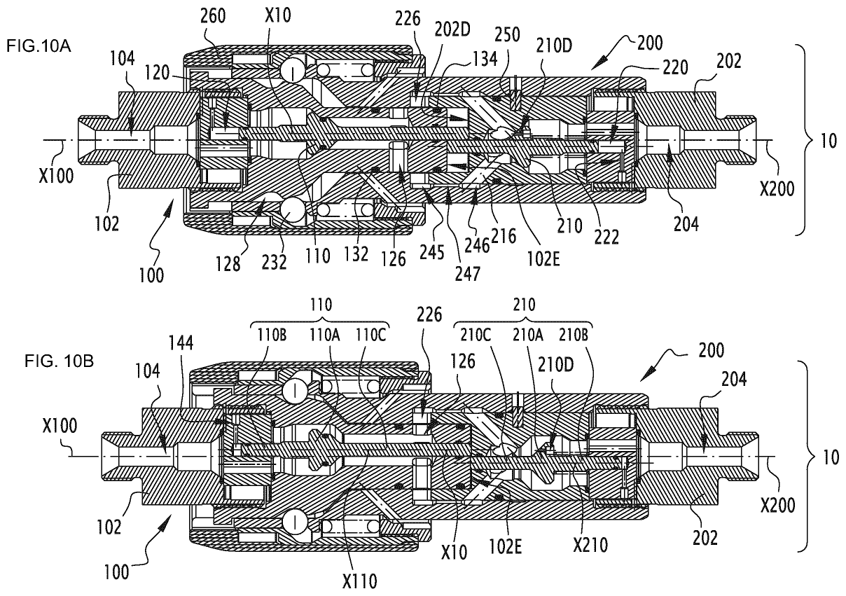

In the third embodiment represented in FIGS. 10A and 10B, respectively in the intermediate coupling position on FIG. 10A and in the coupled configuration on FIG. B, the valve 110 of the male element 100 comprises, as in the first embodiment, a head 110A, a proximal rod 110B, and a distal rod 110C.

Here, the valve 210 of the female element 200 also comprises a head 210A, a proximal rod 210B, and a distal rod 210C that protrudes from the bearing surface 202D.

The valve 110 extends according to a longitudinal axis X110 on which it is centered. The valve 210 extends according to a longitudinal axis X210 on which it is centered. The axes X110 and X210 are parallel to the insertion axis.

The valve 110 is similar to those of the first and second embodiments and operates in the same way. The valve 210 operates in a manner comparable way to the valve 110. The valve head 110A carries a seal similar to the seal 114 of the first embodiment. The valve head 210A is devoid of a seal and comes into abutment against a seat comparable to the seat 212 of the first embodiment under the action of a return spring.

The proximal rod 210B is engaged in an axial housing 220 delimited by the female body 202, in a manner comparable to the proximal rod 110B of the valve 110 which is engaged in a housing 120 of the male body 102, as in the first embodiment. A vent 222 connects the housing 220 to the outside of the female body, as the vent 144 connects the housing 120 to the outside of the male body.

The proximal rod 210C of the valve 210 of the female element 200 is configured to come into abutment against the front end surface 102E of the male body 102, while, as in the first embodiment, the proximal rod 110C of the valve 110 comes into abutment against the bearing surface 202D formed by the female body 202. In other words, the front end surface 102E of the male body constitutes a bearing surface for a proximal rod of valve 210C.

This allows the actuation of the valve 210 of the female element to be performed not by the fluid pressure in the internal conduit 104 but by the body 102 of the male element 100. A double closure is thus achieved within the circuit breaker 10, and the opening positions of both valves 110 and 210 are managed precisely, which allows maximum fluid flow in the coupled configuration of the male and the female elements 100 and 200.

This requires a radial offset, relative to the insertion axis X10, between, on one hand, a contact zone between the male body 102 and valve 210 and, on the other hand, a contact zone between the female body 202 and the valve 110.

In the embodiment of FIGS. 10A and 10B, the central longitudinal axes X110 and X210 of the valves 110 and 210, particularly of the proximal rods 110C and 210C, are radially offset from each other and radially offset from the longitudinal axis X100, respectively X200, which imposes precise radial indexing around the insertion axis X10, between the male and the female elements 100 and 200.

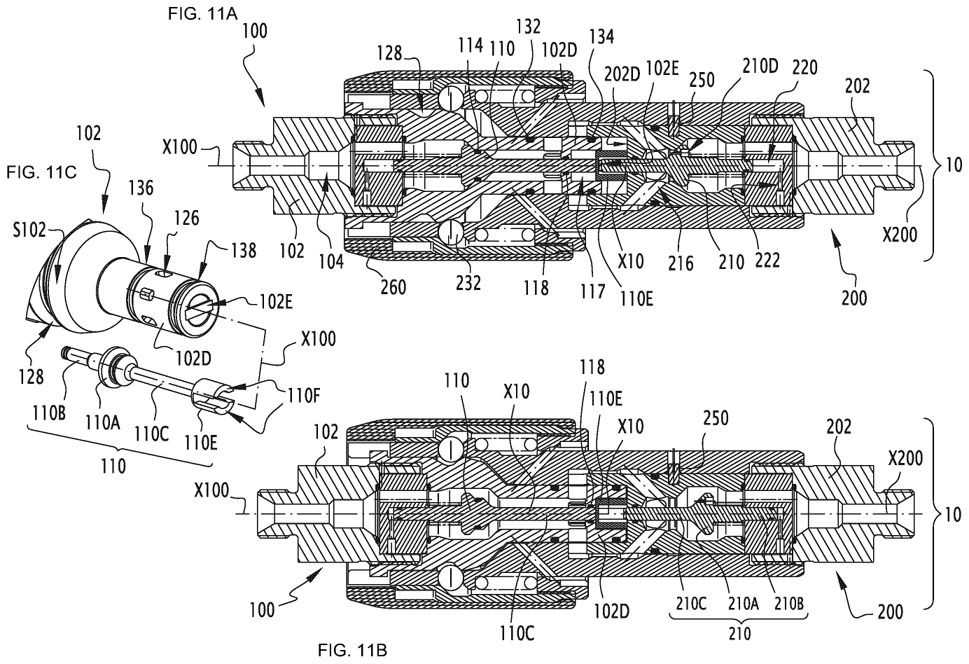

In the fourth embodiment represented in FIGS. 11A, 11B and 11C, each valve 110 of the male element 100 or 210 of the female element 200 is also maneuvered to open by the body of the other element.

In the fourth embodiment, the distal rods 110C and 210C of the valves 110 and 210 belonging respectively to the male element 100 and the female element 200 of the circuit breaker 10 are coaxial, advantageously centered on the insertion axis X10.

The valve 110 of the male element 100 comprises a tip 110E secured to its distal rod 110C, and the front faces 110F of which are in circular segments configured to come into contact with the bearing surface 202D of the female body 202, during insertion as represented in FIG. 11A or in the coupled configuration as represented in FIG. 11B. These front faces 110F are radially offset from a front end surface 102E of the male body, which is here formed by a terminal bar of the male body and forms a bearing surface configured to come into contact with the front end of the proximal rod 210C of the valve 210 of the female element.

During coupling, the contact between the front end surface 102E and the valve 210 is simultaneous with the contact of the tip 110E with the bearing surface 202D.

The tip is configured to protrude from the male body 102 toward the front through two openings provided on either side of the terminal bar, these openings being visible in FIG. 11C. In FIG. 11C, and for clarity of the drawing, the seals 114, 132, and 134 are not represented.

The contact zone between the bearing surface 102E of the male body 102 and the valve 210 and the contact zone between the bearing surface 202D of the female body 202 and the valve 110 are radially offset from each other to the insertion axis X10. In particular, in the fourth embodiment, the contact zone between the bearing surface 202D of the female body 202 and the valve 110 surrounds the contact zone between the bearing surface 102E of the male body 102 and the valve 210.

In the coupled configuration of the male and the female elements, the tip 110E is received in a housing 117 provided within the distal end 102D of the male body 102. The housing 117 has a diameter greater than the sealing diameter between the distal rod 110 and the distal end 102D, this sealing diameter being defined by the first rod seal 118.

In the disconnected configuration or in an intermediate coupling position represented in insert FIG. 11a, the tip 110 protrudes toward the front of the end 102D, particularly from its front end surface 102E.

In the third and fourth embodiments, the head 210A of the valve 210 of the female element 200 is equipped with a slow leak passage 210D, with the same function as the slow leak passage 210D of the second embodiment.

In the second, third, and fourth embodiments, the use of a slow leak passage is optional.

According to one alternative, not represented, of the invention, the indexing of the male and the female bodies 102 and 202 around the insertion axis X10 can be associated with a keying mechanism that allows the coupling of only one type of male body with only one type of female body.

In the third and fourth embodiments, distances comparable to the distances d136 and d138 of the first two embodiments can also be defined, vis a vis a median plane of the first radial passages 126. The distance associated with the distal seal 134 is strictly greater than the distance associated with the proximal seal 132, preferably at least 1.5 times greater, preferably even at least 1.75 times greater.

In all the embodiments, the locking members are elastically returned toward their first locking position, by the elastic force of the locking ring 260 on the balls 232 or by elastic deformation of the spring 233 itself.

In all embodiments, the external inclined surface S102 reduces the insertion force of the male and the female elements 100 and 200 and secures the coupled configuration of these elements. In case of incomplete coupling of these elements, the locking members 232 or 233, in contact with the external inclined surface S102, exert a withdrawal force of the male body from the female body and return these elements to the uncoupled configuration, with their respective valves 110 and 210 closed.

In the example of the figures, the circuit breaker 10 is configured for the passage of liquid hydrogen under pressure, with a pressure comprised between 300 and 900 bar. Alternatively, it is configured for the passage of another pressurized fluid, liquid or gaseous, for example natural gas.

In one alternative, not represented, the axis of the cylinder forming each first radial passage 126 is inclined, up to 45°, relative to the radial direction to the longitudinal axis X100. In this case, the median radial plane to consider is the radial plane passing through the middle, along the longitudinal axis X100, of the opening of the first radial passages at the level of the external peripheral surface 102F of the male body 102.

In one alternative, not represented, the axis of the cylinder A226 forming each second radial passage 226 is inclined, up to 45°, relative to the radial direction to the longitudinal axis X200.

In one alternative, not represented, the seal 114 can cooperate longitudinally with the distal part 102C of the male body 102. The sealing portion of the valve head 110A is then in longitudinal abutment against the male body via the seal 114 in the closed position of the first valve 110. Similarly, the seal 214 can cooperate longitudinally with the intermediate part 202B of the female body 202. The sealing portion of the valve head 210A is then in longitudinal abutment against the female body via the seal 214 in the closed position of the second valve 210.

Any feature described above for one embodiment or alternative, is applicable to other embodiments and alternatives, insofar as it is technically possible.

What is claimed is:

1. A circuit breaker for connecting two sections of a pipeline of a fluid handling installation under pressure, this circuit breaker comprising a male element and a female element intended to be inserted into each other according to an insertion axis, the male element comprising:
a male body centered on the insertion axis and comprising:
a first internal conduit for a circulation of pressurized fluid;
at least one first radial passage connecting the first internal conduit to an external peripheral surface of the male body; and
an external locking notch,
a first valve, movable in the first internal conduit, according to the insertion axis, between an advanced closed position of the first internal conduit and a retracted open position of the first internal conduit, and comprising a closing portion, which is in longitudinal abutment against the male body in the closed position of the first valve; and
a spring pushing the first valve toward the advanced closed position;
the female element comprising:
a female body comprising a second internal conduit for the circulation of pressurized fluid and at least one second radial passage connecting the second internal conduit to an internal volume for receiving the male body in the female body;
a second valve movable in the second internal conduit
at least one locking member received in a locking housing and configured to move from a first locking position, where the locking member is engaged in the external locking notch, to oppose an axial withdrawal of the male body from the female body in a coupled configuration of the male and the female elements, to a second release position, where the axial withdrawal of the male body from the female body is possible, wherein,
in the coupled configuration of the male and the female elements,
the first and second radial passages are in fluid communication;
the, or each locking member is in the first locking position;
the first valve is in the retracted open position;
a proximal seal and a distal seal are arranged, along the insertion axis, on either side of the first and second radial passages and cooperate radially, respectively, with an internal radial surface of the female body delimiting the internal volume and with the external peripheral surface of the male body so as to fluidly isolate the first and second radial passages from an outside of the circuit breaker,
the first valve also comprises a distal rod which is slidably mounted, between the advanced closed position and the retracted open position, in a housing of the male body passing through a distal end of the male body;
a first radial rod seal cooperates radially with the distal rod and with the distal end of the male body;
the female element comprises a bearing surface configured to come into contact with the first valve and displace it, during insertion of the male and the female elements, from the advanced closed position toward the retracted open position;
in an intermediate coupling position of the male and the female elements,
the first valve is in the advanced closed position and in contact with the bearing surface of the female element;
each locking member is not in the first locking position;
the proximal seal and the distal seal are arranged, along the insertion axis, on either side of the first and second radial passages and fluidly isolate the first and second radial passages from the outside of the circuit breaker;
the proximal seal and the distal seal are respectively received in a proximal external peripheral groove and in a distal external peripheral groove of the external peripheral surface of the male body;
a first longitudinal distance, measured parallel to the insertion axis between the distal external peripheral groove and a median radial plane of the first radial passage, is strictly greater than a second longitudinal distance, measured parallel to the insertion axis between the proximal external peripheral groove and the median radial plane.

2. The circuit breaker according to claim 1, wherein a ratio between the first longitudinal distance and the second longitudinal distance is greater than or equal to 1.5, preferably 1.75.

3. The circuit breaker according to claim 1, wherein the female body comprises:
at least one first vent, which radially traverses the female body and fluidly connects the internal volume in front of the second radial passage and the outside of the circuit breaker;
at least one second vent which radially traverses the female body and fluidly connects the internal volume of the female body, behind the second radial passage, and the outside of the circuit breaker,
wherein, in the coupled configuration of the male and the female elements and in the intermediate coupling position, the first and second radial passages are isolated from the first and second vents respectively by the proximal and the distal seals.

4. The circuit breaker according to claim 3, wherein, during a disconnection of the male and the female elements from the coupled configuration, the distal seal is radially facing the second radial passage when the proximal seal comes to radially face the first vent.

5. The circuit breaker according to claim 3, wherein the first vent and the second passage each open onto an internal radial surface of the female body at a level of pockets provided, recessed, locally around the insertion axis, from this internal radial surface.

6. The circuit breaker according to claim 3, wherein the first vent comprises a cylindrical portion inclined relative to the insertion axis and a rear end of which opens onto an external radial surface of the female body and is arranged behind a front end of the cylindrical portion.

7. The circuit breaker according to claim 1, comprising several locking members, wherein each locking member is a ball movable in a locking housing which radially traverses the female body, the female element comprising a locking ring which is slidably mounted around the female body and surrounds the locking members, the locking ring being elastically returned toward a rear, the locking ring being in contact at the rear, in the coupled configuration of the male and the female elements, with the balls by an internal covering surface inclined relative to the insertion axis and diverging toward the rear of the female body.

8. The circuit breaker according to claim 1, wherein the locking member is a locking spring housed in a locking housing formed by an internal peripheral groove of the female body, the locking spring being configured to elastically deform between its first locking position and its second release position.

9. The circuit breaker according to claim 1, wherein each second radial passage is longitudinally delimited by a first part and by a second part of the female body, distinct from the first part, the second part and the first part being secured in longitudinal abutment against each other, and wherein, in the coupled configuration and in the intermediate coupling configuration, the proximal seal cooperates radially with an internal radial surface belonging to the first part and the distal seal cooperates radially with an internal radial surface belonging to the second part.

10. The circuit breaker according to claim 1, wherein each first radial passage and each second radial passage is of elongated section, with a maximum dimension parallel to the insertion axis.

11. The circuit breaker according to claim 1, wherein the first valve comprises a proximal rod sliding in a housing of the male body between the advanced closed position and the retracted open position, with radial interposition of a second rod seal, wherein the first rod seal is mounted in an internal peripheral groove of the male body, while the second rod seal is housed in an external peripheral groove of the proximal rod and wherein a ratio between, on one hand, a diameter of the proximal rod and, on the other hand, a diameter of the distal rod is comprised between 0.95 and 1.

12. The circuit breaker according to claim 1, wherein, in the coupled configuration of the male and the female elements,
a diameter of an internal radial surface of the female body with which the proximal seal cooperates radially is equal to a diameter of an internal radial surface of the female body with which the distal seal cooperates radially; and
a diameter of an external peripheral surface of the male body with which the proximal seal cooperates radially is equal to a diameter of an external peripheral surface of the male body with which the distal seal cooperates radially.

13. The circuit breaker according to claim 1, wherein the bearing surface, configured to come into contact with the first valve, is formed on the female body.

14. The circuit breaker according to claim 13, wherein the second valve comprises a distal rod which is slidably mounted in a sealed manner in a through housing of the female body, wherein the male body forms a bearing surface configured to come into contact with the second valve and displace it, during the insertion of the male and the female elements, from an advanced closed position toward a retracted open position and wherein a contact zone between the bearing surface of the male body and the second valve and a contact zone between the bearing surface of the female body and the first valve are radially offset from each other.

15. A fluid handling installation under pressure comprising a source of pressurized fluid and a first part of a connector intended to be coupled to a second part of a connector connected to a storage or use volume of the fluid, the first part of the connector being fluidly connected to the source by a pipeline, wherein a circuit breaker according to claim 1 is fluidly connected to the source by a first section of the pipeline and to the first part of the connector by a second section of the pipeline.
